(19) United States
(12) Patent Application Publication
(10) Pub. No.: US 2023/0376699 A1
(43) Pub. Date: Nov. 23, 2023

(54) On-Device Real-Time Translation of Media Content on a Mobile Electronic Device

(71) Applicant: Google LLC, Mountain View, CA (US)

(72) Inventors: Brandon Charles Barbello, Mountain View, CA (US); Shenaz Zack, Foster City, CA (US); Tim Wantland, Pacifica, CA (US); Khondokar Sami Iqram, San Mateo, CA (US); Nikola Radicevic, San Francisco, CA (US); Prasad Modali, Fremont, CA (US); Jeffrey Robert Pitman, Santa Clara, CA (US); Svetoslav Ganov, Mountain View, CA (US); Qi Ge, Mountain View, CA (US); Jonathan D. Wilson, Barrington, IL (US); Masakazu Seno, Cupertino, CA (US); Xinxing Gu, Mountain View, CA (US)

(73) Assignee: Google LLC, Mountain View, CA (US)

(21) Appl. No.: 18/245,305

(22) PCT Filed: Dec. 18, 2020
(86) PCT No.: PCT/US2020/065983

§ 371 Date: Mar. 14, 2023

(51) Int. Cl. G06F 40/58

(52) U.S. Cl. CPC G06F 40/58

(57) ABSTRACT

This document describes methods and systems of on-device real-time translation for media content on a mobile electronic device. The translation is managed and executed by an operating system of the electronic device rather than within a particular application executing on the electronic device. The operating system can translate media content, including visual content displayed on a display device of the electronic device or audio content output by the electronic device. Because the translation is at the OS level, the translation can be implemented, automatically or based on a user input, across a variety of (including all) applications and a variety of content on the electronic device to provide a consistent translation experience, which is provided via a system UI overlay that displays translated text as captions to video content or as a replacement to on-screen text.

### BACKGROUND

Translation services have become widely used throughout the world to facilitate communication across language barriers. Advancements in machine translation have increased the accuracy of translations, including using punctuation, slang, idioms, colloquialisms, and so forth. On mobile devices, translation services are generally built inside an application to function only within that application, including a web browser or virtual assistant. These conventional translation services typically communicate with a backend server via a network connection to allow the backend server to compute the translations. Accordingly, conventional translation services are generally limited to specific contexts within an application on the mobile device.

### SUMMARY

This document describes methods and systems for on-device real-time translation of media content on a mobile electronic device. The translation is managed and executed by an operating system (OS) of the electronic device rather than within a particular application (app) executing on the electronic device. The OS can translate media content, including text displayed on a display device of the electronic device or audio output by the electronic device. Because the translation is at the OS level, the translation can be implemented across a variety of (e.g., all) applications and a variety of (e.g., all) content on the electronic device to provide a consistent translation experience. The OS-level translation can be provided via a system user interface (UI) overlay that displays translated text corresponding to the media content. The system UI overlay may be applied over on-screen text to re-render the text as translated text (in a user-preferred language), which appears similar to native content in the application. Further, the system UI overlay may be usable on virtually any application on the electronic device, including first-party (1P) applications and third-party (3P) applications, without requiring special integration.

In some aspects, a method is disclosed for on-device real-time translation of media content on a mobile electronic device. The method includes identifying, at an operating-system level of the mobile electronic device, an original human language of media content that is output by an application running on the electronic device. In an example, the original human language is different than a target human language defined by a user of the mobile electronic device. Further, the method includes translating, at the operating-system level, the media content from the original human language of the media content into translated text in the target human language. The media content may be translated based on translation models stored in a memory of the mobile electronic device. In addition, the method includes generating, at the operating-system level, a system UI overlay for display via a display device of the mobile electronic device. The method also includes rendering, at the operating-system level, the system UI overlay over a portion of displayed content corresponding to the application, where the system UI overlay includes the translated text.

In other aspects, a mobile electronic device is disclosed. The mobile electronic device includes a display device, one or more processors, and memory. The memory stores translation models usable for translation of text from an original human language to a target human language. In addition, the memory stores instructions that, when executed by the one or more processors, cause the one or more processors to implement a translation-manager module to provide on-device real-time translation of media content that is output by the electronic device by performing the method disclosed above.

This summary is provided to introduce simplified concepts concerning on-device real-time translation of media content on a mobile electronic device, which is further described below in the Detailed Description and Drawings. This summary is not intended to identify essential features of the claimed subject matter, nor is it intended for use in determining the scope of the claimed subject matter.

### BRIEF DESCRIPTION OF THE DRAWINGS

The details of one or more aspects of on-device real-time translation of media content are described in this document with reference to the following drawings. The same numbers are used throughout the drawings to reference like features and components:

FIG. 1 illustrates an example electronic device that implements on-device real-time translation of media content;

FIG. 2 illustrates an example implementation of the example electronic device from FIG. 1 in more detail;

FIG. 3 illustrates an example implementation of the translation-manager module from FIG. 1 in more detail;

FIG. 4 illustrates an example implementation of full-page translation in a messaging application on the electronic device;

FIG. 5 illustrates an example implementation of single-message translation on the electronic device;

FIG. 6 illustrates an example implementation of automatic translation of outgoing messages in a messaging application on the electronic device;

FIG. 7 illustrates example implementation of automatic translation of incoming messages in a messaging application on the electronic device;

FIG. 8 illustrates an example implementation of real-time speech translation during a live video call on the electronic device;

FIG. 9 illustrates an example implementation of real-time speech translation during playback of a video on the electronic device;

FIG. 10 depicts a method for on-device real-time translation of media content on a mobile electronic device;

FIG. 11 depicts a method for a copy and translate function; and

FIG. 12 depicts a method for requesting user input for determining a target human language for translation.

### DETAILED DESCRIPTION

### Overview

This document describes methods and systems for on-device real-time translation of media content on a mobile device. The techniques described herein provide OS-level translation that can be implemented across a variety of (e.g., all) applications executed on the device, which provides a consistent user experience. These methods and systems can enable a user of the device to watch media in nearly any language, read nearly any text, and message another person in nearly any language. With a system user interface (UI) overlay, translations can be applied to video content (e.g., recorded or live) and audio content (e.g., a podcast) with a box of translated subtitles that the user can resize and move around the screen. Similarly, the user can apply the system UI overlay to on-screen text to re-render the text as translated text in another language, with the re-rendering being near-invisible and appearing as native content within an application. Providing the system UI overlay over the on-screen text may ensure that the oftentimes limited screen space of the device is efficiently utilized, and may ensure that there is minimal change to a user's experience interacting with the device. Further, the system UI overlay can be applied to a chat conversation, where incoming text can be translated and re-rendered in the user's preferred language, and outgoing text can be translated and sent in the recipient's preferred language. Because the OS-level translation can be implemented using a system UI overlay outside of a particular application, the translation can apply to first-person and third-person applications without requiring special integration. In addition, because the translation is performed on-device and not over a network, the translation functionality is privacy-friendly and does not require encryption for transmission. Managing and executing the translation at the operating-system level of the electronic device rather than within the particular applications executing on the electronic device can mean it is not necessary for each individual application on the electronic device to have its own respective translation service built inside. This can result in the applications being simpler, smaller, and therefore taking up less storage space in the memory of the electronic device.

While features and concepts of the described methods and systems for on-device real-time translation of media content on a mobile device can be implemented in any number of different environments, aspects are described in the context of the following examples.

### Example Device

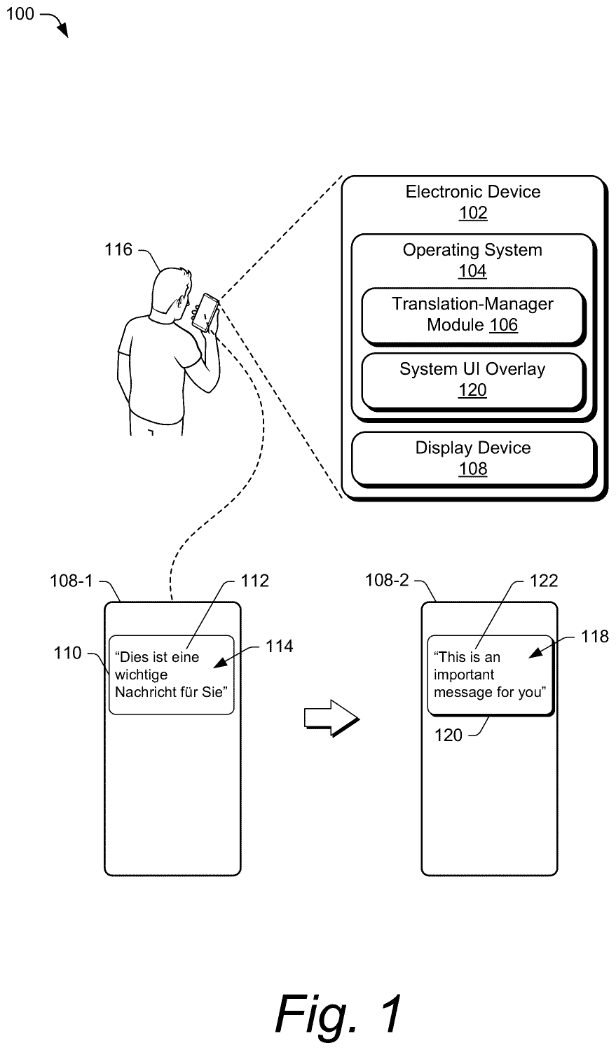

FIG. 1 illustrates an example implementation 100 of a mobile electronic device (e.g., electronic device 102) having an operating system 104 (OS 104) and a translation-manager module 106 executed at the OS level to provide on-device real-time translation of media content on the electronic device 102 in the form of text presented via a display device 108 of the electronic device 102. In one example, the electronic device 102 receives and displays, via display device 108-1, a text message 110 having text 112 in a first human language (e.g., an original human language 114) that is foreign to a user 116 of the electronic device 102 (e.g., in a non-native language of the user 116 or a language that the user 116 does not understand). Here, the original human language 114 is German. Based on user-defined preferences or user selection, the OS 104 can implement the translation-manager module 106 to recognize the original human language 114 of the text 112 and translate the text 112 (automatically or based on the user selection) to a second human language (e.g., a target human language 118, which is a user-preferred language or a user-selected language). The OS 104 can then provide a system UI overlay 120, including translated text 122 in the target human language 118.

As described herein, these techniques for real-time translation can be implemented across different applications running on the electronic device 102, including instant-messaging applications, audio or video players, and live-stream video applications. In implementations of video playback, live-stream video rendering, or audio playback, the translated text may be rendered as captions or subtitles.

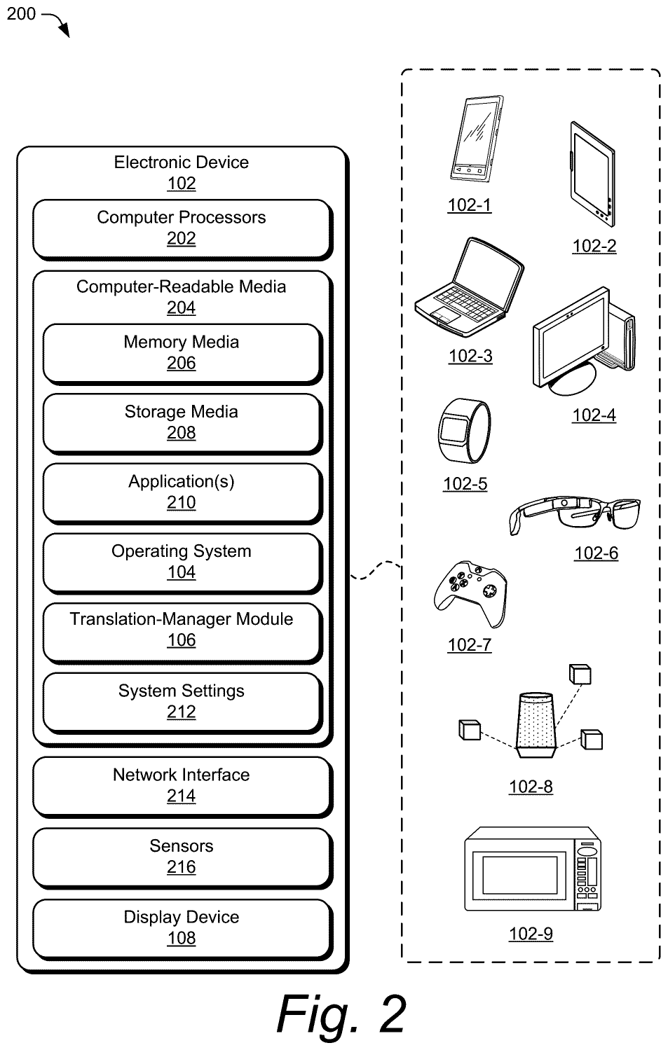

In more detail, consider FIG. 2, which illustrates an example implementation 200 of the electronic device from FIG. 1. The electronic device 102 of FIG. 2 is illustrated with a variety of example devices, including a smartphone 102-1, a tablet 102-2, a laptop 102-3, a desktop computer 102-4, a computing watch 102-5, computing spectacles 102-6, a gaming system 102-7, a home-automation and control system 102-8, and a microwave 102-9. The electronic device 102 can also include other devices, e.g., televisions, entertainment systems, audio systems, automobiles, drones, track pads, drawing pads, netbooks, e-readers, home security systems, and other home appliances. Note that the electronic device 102 can be mobile, wearable, non-wearable but mobile, or relatively immobile (e.g., desktops and appliances).

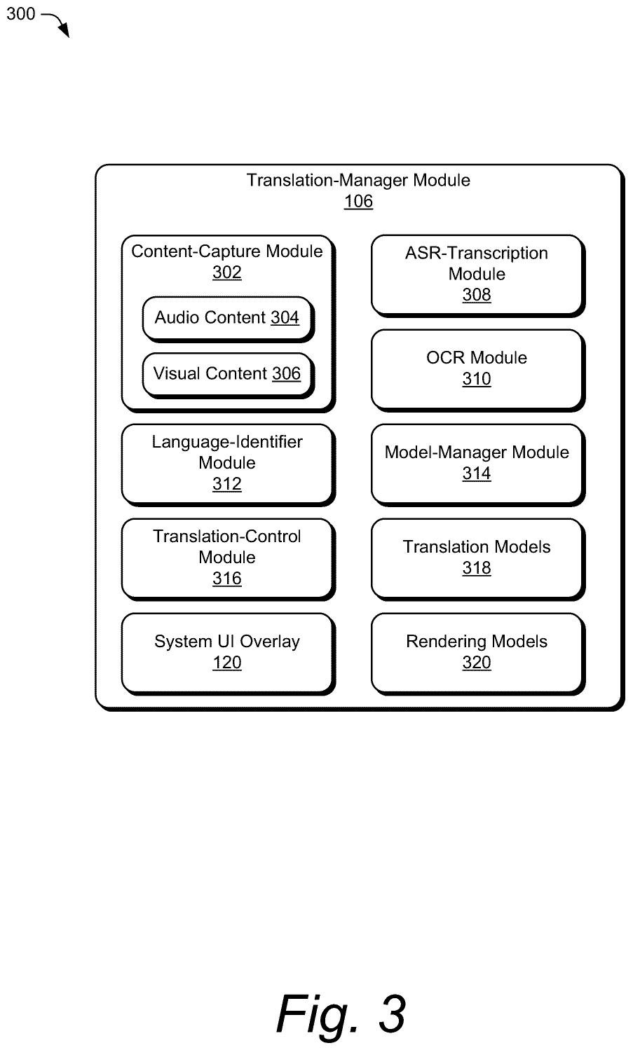

The electronic device 102 also includes one or more computer processors 202 and one or more computer-readable media 204, which includes memory media 206 and storage media 208. Applications 210 and/or the operating system 104 implemented as computer-readable instructions on the computer-readable media 204 can be executed by the computer processors 202 to provide some or all of the functionalities described herein. For example, the computer-readable media 204 can include the translation-manager module 106, which is described in FIG. 3 in more detail. The translation-manager module 106 is configured to provide on-device, OS-level, real-time translation of media content on the electronic device 102. In aspects, the translation-manager module 106 provides such real-time translation based on system settings 212, which include translation settings defined by the user prior to the translation. The system settings 212 may be set by the user during device setup or anytime thereafter.

The electronic device 102 may also include a network interface 214. The electronic device 102 can use the network interface 214 for communicating data over wired, wireless, or optical networks. By way of example and not limitation, the network interface 214 may communicate data over a local-area-network (LAN), a wireless local-area-network (WLAN), a personal-area-network (PAN), a wide-area-network (WAN), an intranet, the Internet, a peer-to-peer network, point-to-point network, or a mesh network.

Various implementations of the translation-manager module 106 can include a System-on-Chip (SoC), one or more Integrated Circuits (ICs), a processor with embedded processor instructions or configured to access processor instructions stored in memory, hardware with embedded firmware, a printed circuit board with various hardware components, or any combination thereof.

The electronic device 102 also includes one or more sensors 216, which can include any of a variety of sensors, including an audio sensor (e.g., a microphone), a touch-input sensor (e.g., a touchscreen), an image-capture device (e.g., a camera or video-camera), proximity sensors (e.g., capacitive sensors), or an ambient light sensor (e.g., photodetector).

The electronic device 102 can also include a display device, e.g., the display device 108. The display device 108 can include any suitable display device, e.g., a touchscreen, a liquid crystal display (LCD), thin film transistor (TFT) LCD, an in-place switching (IPS) LCD, a capacitive touchscreen display, an organic light-emitting diode (OLED) display, an active-matrix organic light-emitting diode (AMOLED) display, super AMOLED display, and so forth. The display device 108 may be referred to as a screen, such that content may be displayed on-screen.

FIG. 3 illustrates an example implementation 300 of the translation-manager module from FIG. 1 in more detail. Although FIG. 3 shows various entities and components as part of the translation-manager module 106, any of these entities and components may be separate from the translation-manager module 106 such that the translation-manager module 106 accesses and/or communicates with them to manage the on-device real-time translation of media content on the electronic device 102.

In FIG. 3, the translation-manager module 106 may include a content-capture module 302 configured to capture media content (e.g., audio content 304, visual content 306). The audio content 304 may include audio output by an application 210 (e.g., music player, video player, videotelephony application, live-stream video player) on the electronic device 102. The visual content 306 may include any text displayed on the display device 108, including short message service (SMS) messages, chat messages, emails, news articles, websites, subtitles to videos, captions to videos, and so forth.

The translation-manager module 106 may also include an automatic speech recognition (ASR)-transcription module 308, optical character recognition (OCR) module 310, a language-identifier module 312, a model-manager module 314, a translation-control module 316, translation models 318, the system UI overlay 120, and rendering models 320.

The ASR-transcription module 308 is configured to transcribe the audio content 304 captured by the content-capture module 302. The language-identifier module 312 is configured to determine a language of the audio content 304 and/or the visual content 306. In some aspects, the language-identifier module 312 provides an indication (e.g., language ID) that identifies the human language of the audio content 304 to enable the ASR-transcription module 308 to transcribe the audio content 304 into visual content in the corresponding human language. The language-identifier module 312 can also provide the language ID to the translation-control module 316 to enable the translation-control module 316 to identify the original human language of the media content and initiate the translation.

The OCR module 310 is configured to convert images of text into machine-encoded text. For example, the OCR module 310 can convert the visual content 306 into a form usable by the translation-control module 316 for translation. Using OCR results output by the OCR module 310, the language-identifier module 312 can identify the language of the visual content 306 and provide the language ID to the translation-control module 316.

The translation models 318 (e.g., cascaded set of models) include machine learning models trained on human languages and translations between the human languages. The translation models 318 may include models trained on a particular pair of human languages (e.g., German, French, English, Spanish, Portuguese, Mandarin Chinese, Japanese, Arabic, Hindi, Armenian) as they translate from one to the other. The translation models 318 may also include models trained on semantic natural-language understanding (e.g., sentence fragments, slang, colloquialisms, and context from phrase to phrase) of a particular human language. Some human languages have pronoun drop in which the pronoun (e.g., he, she, we, I, you) can be dropped. As such, a sentence in isolation may not provide sufficient information to know if the pronoun is “he” or “she,” for example, which may result in translation errors and deficiencies. When translating from a first language with pronoun drop (e.g., Spanish) to a second language that requires the presence of the pronoun (e.g., English), the pronoun may need to be predicted and added (or restored) to the translated text. Accordingly, some of the translation models 318 may be trained to analyze and determine the context of one or more preceding phrases to enable a pronoun to be restored in a translated phrase, making the translation a contextual translation.

In addition, the translation models 318 may include models trained on punctuation. In some aspects, punctuation models may be trained to determine, predict, and provide punctuation corresponding to unspoken punctuation in the audio content 304, e.g., for transcription. The punctuation models also analyze the punctuation of the visual content 306 to provide appropriate punctuation in the translated text for improved accuracy of the translation.

The model-manager module 314 is configured to manage the translation models 318. For example, the model-manager module 314 can, based on user input (e.g., at device setup, at setup of translation services, or at the time of a translation request), retrieve, from one or more remote sources over a network, appropriate translation models 318 for one or more user-selected human languages). Further, the model-manager module 314 can aggregate the translation models 318 and bring them to one place for use on the electronic device 102. The model-manager module 314 can also manage updates to the translation models 318 and provide access to one or more of the translation models 318 to assist with transcription and/or translation. The model-manager module 314 can also indicate whether a requested translation model is missing, e.g., not included, in the translation models 318 and therefore needs to be downloaded or otherwise retrieved from a remote source.

The translation-control module 316 is configured to manage the real-time translation of the captured media content. In aspects, the translation-control module 316 communicates with the model-manager module 314 to access the translation models 318 for translation. The access is based, at least in part, on the language ID(s) provided by the language-identifier module 312. In addition to the language ID identifying the language (e.g., the original human language 114) of the captured media content, the language-identifier module 312 can also provide a target-language ID identifying a target language (e.g., user-preferred or user-selected language) for translation. In aspects, the target-language ID is obtained from system settings (e.g., the system settings 212 from FIG. 2). The system settings 212 may define the target human language 118 based on a user input that indicates the user-preferred language. The target human language 118 may be predefined (e.g., previously selected by the user 116 in the system settings 212, including during device setup) or user-selected based on a prompt presented in response to identification of a foreign language in the captured media content. Any of the language-identifier module 312, the model-manager module 314, or the translation-control module 316 can determine the target human language 118 based on information obtained from the system settings 212. The system settings 212 may also indicate a level of proficiency selected by the user for the translation. In an example, the system settings 212 may offer different levels of proficiency for translation, including a first option to translate all incoming messages, a second option for message-by-message translation, or a third option for word-by-word translation. The user 116 can select a level of proficiency in the system settings 212 to enable the electronic device 102 to automatically perform real-time translation at the selected level of proficiency. In this way, if the user 116 has some understanding of a foreign language and only wishes to translate a certain phrase or word, the user can indicate which word(s) or phrase(s) to translate, rather than having all incoming messages translated automatically. Accordingly, through the system settings 212 (e.g., translation settings on the electronic device 102), the user 116 can customize the auto-translation experience across the device.

In an example, the user 116 may select one or more human languages to make available for on-device real-time translation. Based on the user selection, the model-manager module 314 may initiate a download of appropriate translation models 318 corresponding to the selected human language(s). In addition, the user 116 may select a preferred language, which may be used for automatic translation or, alternatively, as a first-suggested language when prompting the user for translation. The translation settings may be accessible in the device settings and may have a toggle control to toggle the auto-translation services on and off. Shortcuts may also be provided on the electronic device 102 to opt-in or dismiss translation, toggle translation on and off, or access preferences. These shortcuts are provided at the OS level and are not built within, and therefore limited to, a particular application (“app”) on the electronic device 102. Thus, a consistent user experience flow and implementation can be provided across applications and scenarios presented on the electronic device 102.

Using the captured media content (e.g., the audio content 304 or the visual content 306), the translation models 318, the system settings 212, and input from one or more of the model-manager module 314 and the language-identifier module 312, the translation-control module 316 can translate the captured media content into translated text (e.g., the translated text 122) in the target human language 118.

The translation-manager module 106 (or the translation-control module 316) is configured to generate an overlay (e.g., system UI overlay 120) for display on the display device 108. The overlay includes the translated text 122. In aspects, the overlay may include a user-selectable control to change the translated text 122 to a different target language or revert back to the original human language 114. Further, the translation-control module 316 may access the rendering models 320 to present the translated text 122 in a substantially similar style and format as that of the originally-displayed text in the original human language 114. In an example, the rendering models 320 are used to cause the translated text to substantially match one or more visual characteristics (e.g., size, font, style, format, color) of native content of the application 210.

These and other capabilities and configurations, as well as ways in which entities of FIGS. 1-3 act and interact, are set forth in greater detail below. These entities may be further divided, combined, and so on. The implementation 100 of FIG. 1 and the detailed illustrations of FIG. 2 through FIG. 12 illustrate some of many possible environments and devices capable of employing the described techniques.

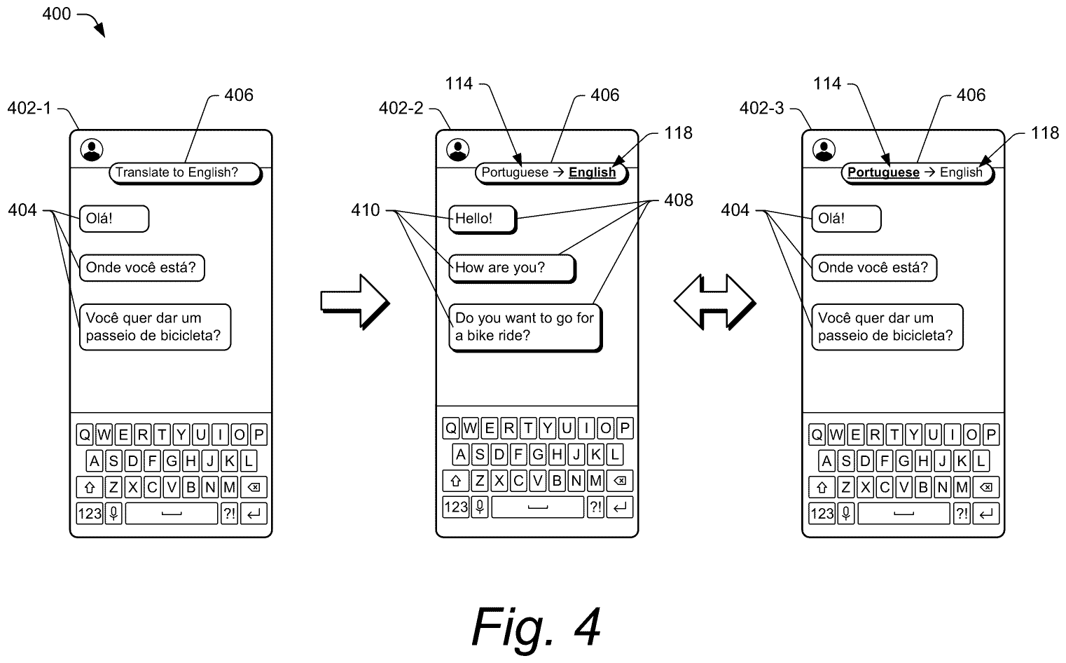

FIG. 4 illustrates an example implementation 400 of full-page translation in a chat application on the electronic device. The example implementation 400 illustrates a display 402 (e.g., the display device 108) in different instances 402-1, 402-2, and 402-3. In the instance 402-1, multiple incoming chat messages 404 are displayed. Based on predefined user preferences (e.g., translation settings set in device settings), the electronic device 102 determines the chat messages 404 to be in a human language (e.g., Portuguese) that is different than a user-preferred language (e.g., English). Then, the electronic device 102 generates an overlay 406 (e.g., system UI overlay 120 from FIG. 1), prompting the user to translate the chat messages 404 to English. If the user selects the prompt in the overlay 406, then the electronic device 102 translates the displayed chat messages 404.

As shown in the instance 402-2, the electronic device 102 may generate one or more system UI overlays 408 (e.g., an overlay for each individual message or a single overlay having multiple (including all) the translated messages) on top of the chat application to re-render the chat messages 404 as translated text 410 in English. In addition, the overlay 406 may indicate the original human language 114 of the chat messages and the target human language 118 of the translated text. For example, the overlay 406 shows “Portuguese→English” to indicate that the original chat messages were in Portuguese and the displayed text (e.g., the translated text 410 in the system UI overlays 408) is currently in English, which is emphasized in bold and underlined. Any suitable emphasis can be used, including highlighting, italics, color, size, font, and so on. In aspects, the overlay 406 may act as a toggle control to switch, based on user selection, back and forth between the original human language 114 and the target human language 118. In an example, if the user selects the overlay 406 or the original human language 114 (e.g., “Portuguese”) in the overlay 406, the electronic device 102 can revert the displayed text to Portuguese, as shown in instance 402-3. The displayed text in the instance 402-3 may be displayed in the original human language 114 in the system UI overlay. In another example, the system UI overlay may be removed to display the underlying chat messages 404 in the chat application in the original human language 114. The overlay 406 can also emphasize the original human language 114 (e.g., by showing “Portuguese→English”) to indicate that the displayed text (e.g., the chat messages 404) is currently in Portuguese. Using the overlay 406, the user can toggle the display back and forth (e.g., between instances 402-2 and 402-3) between the target human language 118 and the original human language 114.

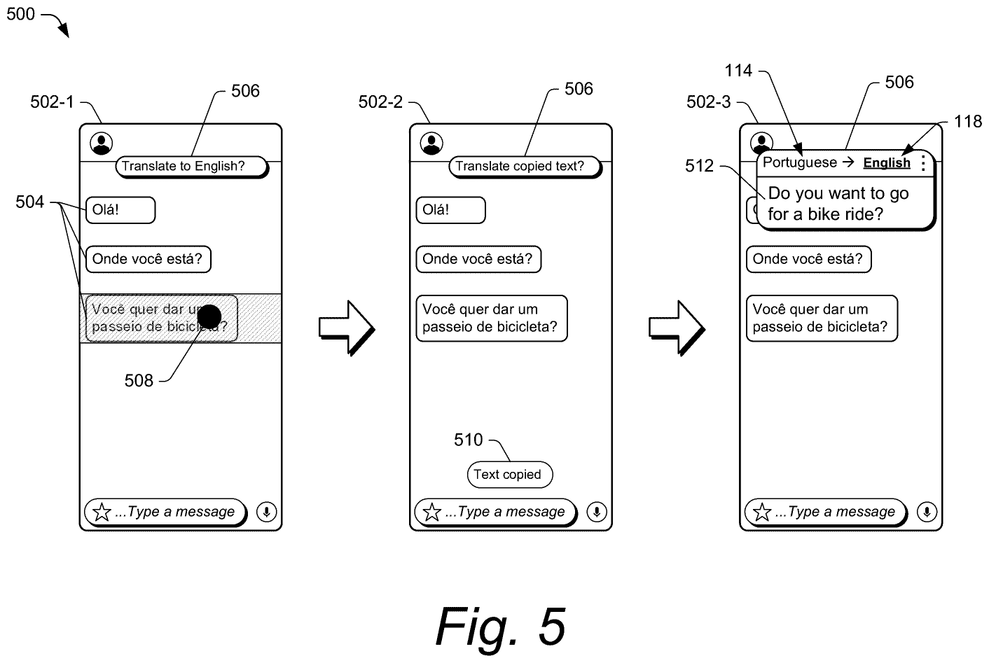

FIG. 5 illustrates an example implementation 500 of single-message translation on the electronic device. As described above, the user can customize the translation experience by setting a desired level of proficiency for the real-time translation. The illustrated example is based on a situation where the user has set the translation settings for message-by-message translation. The example implementation 500 illustrates a display 502 (e.g., display device 108) in different instances 502-1, 502-2, and 502-3. In the example shown in the instance 502-1, the electronic device 102 has recognized a human language in displayed chat messages 504 that is not the user-preferred language and has generated an overlay (e.g., overlay 506) to prompt the user to translate the chat messages 504. Rather than translating all of the chat messages 504 displayed on the display 502, the user can select an individual message to translate. Perhaps the user has a limited understanding of the original human language sufficient to read some, but not all, of the chat messages 504. Thus, the user may desire to translate a single chat message rather than all of the displayed chat messages.

As shown in FIG. 5, the electronic device 102 can perform a single-message translation based on a copy-and-translate command. For example, the user can select (e.g., touch input 508) one of the chat messages 504, which is highlighted to indicate user selection. In aspects, the text of the selected chat message can be copied, as indicated in the instance 502-2 by a UI element 510. In some instances, the user selection can initiate a display of a menu having a selectable copy command. In another example, the user selection can cause the electronic device 102 to automatically copy the text of the text selected chat message. Further, the electronic device 102 may prompt the user to translate the copied text, including via the overlay 506. Based on a user input, the electronic device 102 translates the copied text and presents translated text 512 to the user via the display 502 (e.g., shown in the instance 502-3). In some aspects, the translated text 512 may be included in the overlay 506 with an indication of the original human language 114 and the target human language 118. Alternatively, the translated text 512 can be displayed in a separate overlay over the copied text as a re-rendering of the copied text in the target human language 118. In another example, the translated text 512 can be included in an overlay over the copied text together with the copied text, such that the overlay includes both the copied text in the original human language 114 and the translated text in the target human language 118, simultaneously.

The electronic device 102 can also translate a single word based on the copy-and-translate command described above and based on the translation settings being set for word-by-word translation. For example, the user may select an individual word, for example, in one of the chat messages 504. The selected word can be copied and translated to the target human language 118 either automatically in response to the user selection of the word or in response to an additional user input initiating the copy and translation. The translated word can then be presented in the overlay 506 or in a separate overlay that may be positioned proximate to the selected word. Accordingly, based on the user selection, the on-device real-time translation can be applied to a single term, multiple terms, a phrase, multiple phrases, or all text displayed on the display device 108.

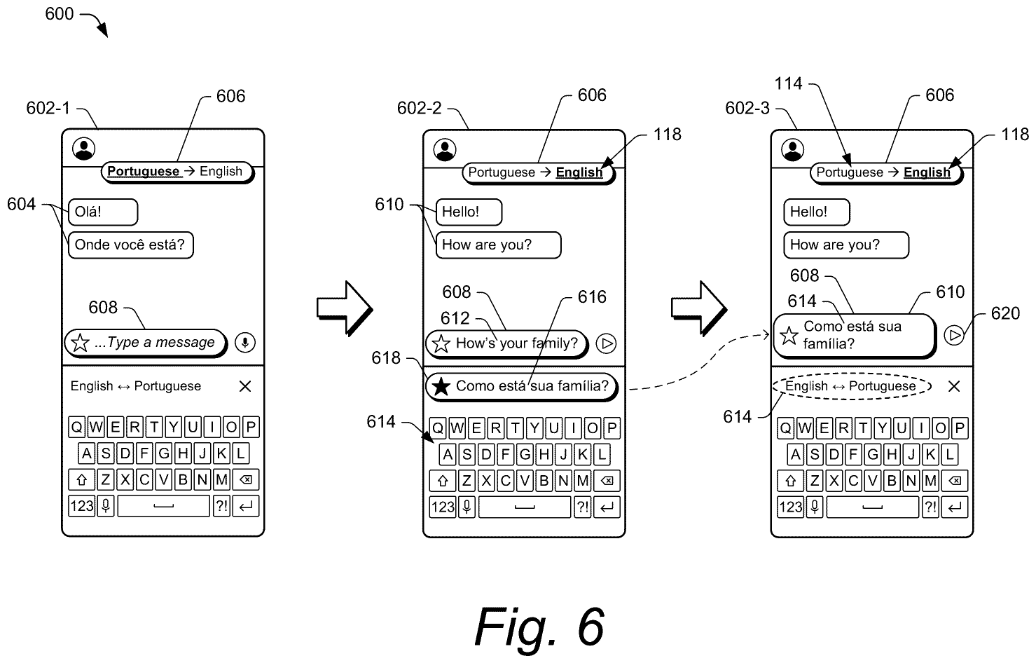

FIG. 6 illustrates an example implementation 600 of automatic translation of outgoing messages in a messaging application on the electronic device. The example implementation 600 illustrates a display 602 (e.g., display device 108) in different instances 602-1, 602-2, and 602-3. In the example shown in the instance 602-1, chat messages 604 are received and displayed in Portuguese, as indicated by the overlay 606. The application includes an input box 608 for a user to enter text, e.g., an outgoing text message. If automatic translation for incoming messages is enabled (e.g., described in FIG. 4), the automatic translation for outgoing messages can also be enabled. In the example illustrated in the instance 602-2, automatic translation has been enabled, and chat messages 604 (from the instance 602-1) are now displayed as translated text 610 in the target human language 118. Here, the user has entered a draft message 612 by providing typed input via a keyboard (e.g., virtual keyboard 614) or by providing a voice command (e.g., speech) via a microphone (not shown) of the electronic device 102, where the voice command is transcribed into the draft message 612. As the draft message 612 is entered, or upon completion of the draft message 612, the electronic device 102 may translate the draft message 612 and provide a translation 616 on the display 602 in an overlay 618 (e.g., the system UI overlay 120). In one example, the translation 616 and the overlay 618 are presented at the top of the virtual keyboard 614. However, the translation 616 and the overlay 618 can be presented at any suitable location on the display 602.

If the user selects the overlay 618 with the translation 616, the electronic device 102 can replace the draft message 612 with the translation 616 prior to transmitting the outgoing message. In an example, the draft message 612 is replaced by the translation 616 in the input box 608, as shown in the instance 602-3. Then, the user can trigger a “send” button 620 to send the translation 616 as the outgoing message. In this way, the user can send outgoing messages in the native or preferred language of a recipient. In addition, the user can select a toggle command 622 to switch between the original human language 114 and the target human language 118. In some aspects, the user can select the toggle command 622 to change the target human language 118 of the outgoing message (e.g., the translated text 610 that is replacing the draft message 612) to a new target human language.

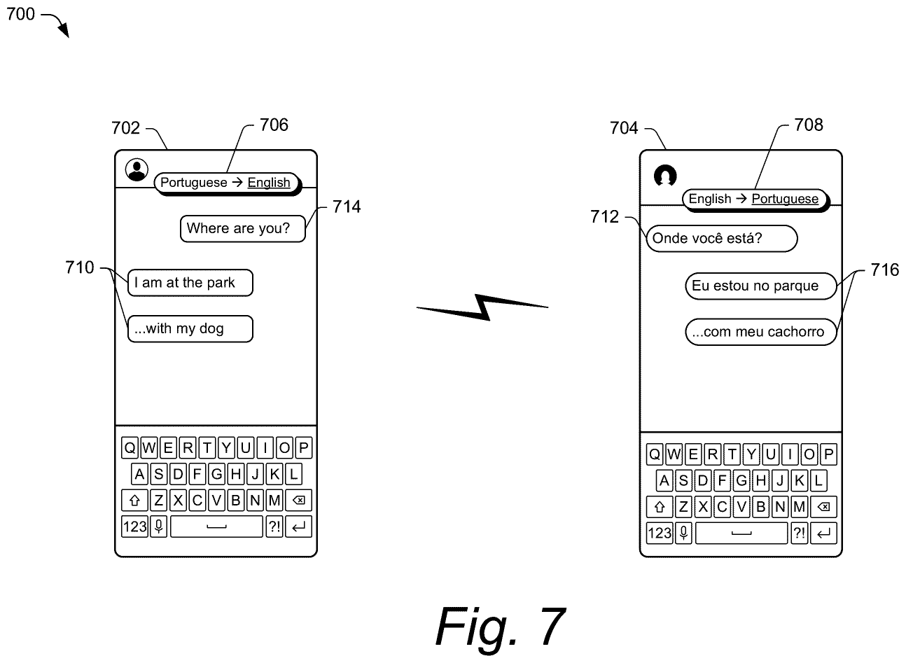

FIG. 7 illustrates an example implementation 700 of automatic translation of incoming messages in a messaging application on the electronic device. The example implementation shows two devices (e.g., a first device 702 and a second device 704) communicating with one another via a messaging application. A user (e.g., “John”) of the first device 702 speaks English and has enabled automatic translation from Portuguese to English, as indicated in overlay 706. On the other hand, a user (e.g., “Maria”) of the second device 704 speaks Portuguese and has enabled automatic translation from English to Portuguese, as indicated in overlay 708. Accordingly, the techniques described herein enable each device (e.g., the first and second devices 702 and 704, respectively) to view incoming messages (e.g., messages 710 and 712, respectively) in their preferred human language. Outgoing messages (e.g., messages 714 and 716, respectively) can also be displayed in their preferred human language and are translated at the recipient device upon receipt. By automatically translating messages in this way, fewer inputs are required by the user for translation, causing communication across languages to be simpler, easier, and quicker.

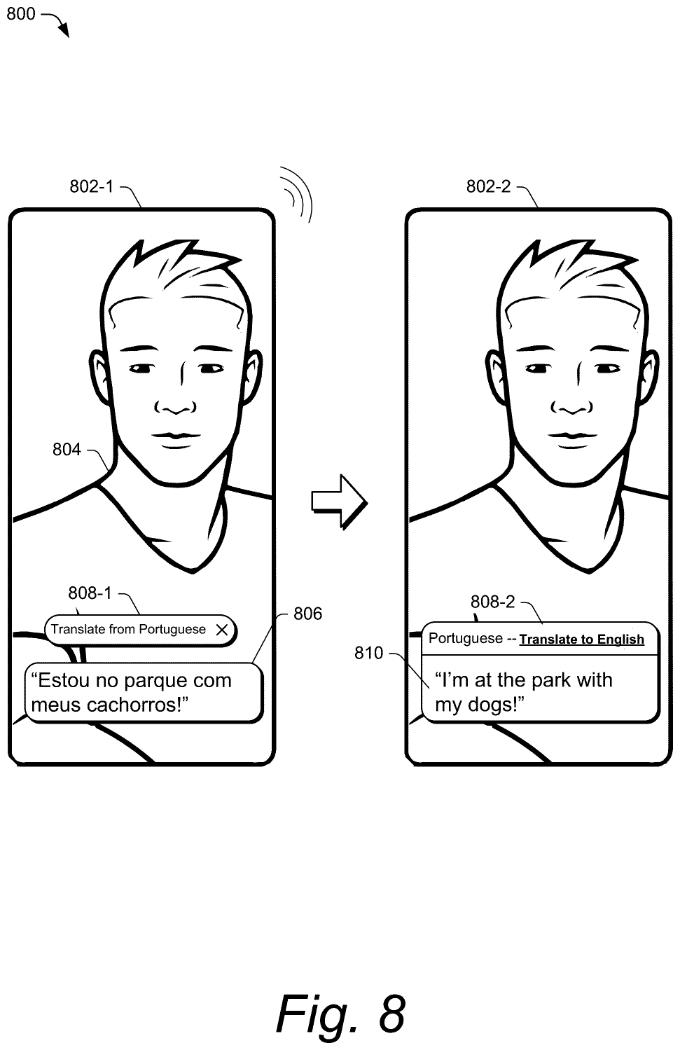

FIG. 8 illustrates an example implementation 800 of real-time speech translation during a live video call on the electronic device. For example, a display 802 (e.g., display device 108) is shown in different instances 802-1 and 802-2. A user may be conducting a video call via a live-stream video call application with a person 804 speaking a foreign language. In some aspects, the ASR-transcription module 308 may be implemented to provide captions 806 of the foreign language as it is spoken by the person 804. The translation-manager module 106 can recognize that the foreign language is not the preferred language of the user of the device and provide an overlay 808-1 to prompt the user to translate the speech to the user's preferred human language. Based on a user input (e.g., user selection), the translation-manager module 106 translates the captions and re-renders the captions in the overlay with translated text 810. For example, the instance 802-2 includes an expanded overlay 808-2 (e.g., expanded from the overlay 808-1 in the instance 802-1), which includes the translated text 810. In another example, the translated text 810 may be included in another overlay that is separate from the overlay 808-1. In yet another example, the overlay 808-2 may include both the translated text 810 and the original captions 806 to allow the user to view both simultaneously.

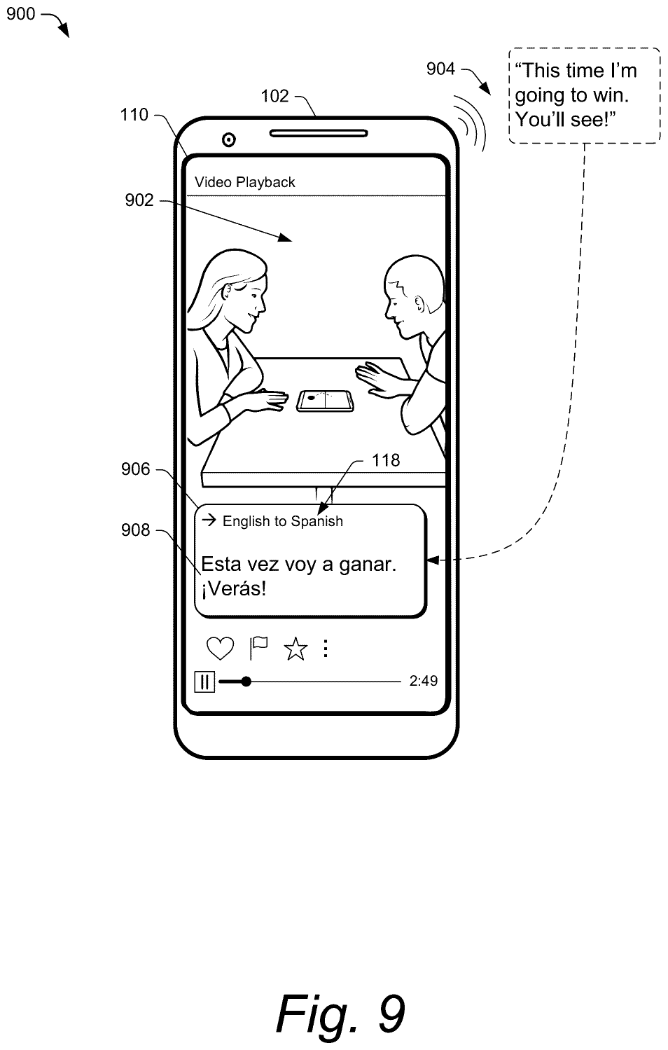

FIG. 9 illustrates an example implementation 900 of real-time speech translation during playback of a video on the electronic device. For example, the electronic device 102 may run a media player application for playback of a video 902 via the display device 108. The electronic device 102 can generate captions for audio (e.g., audio 904) from the video 902 during playback of the video 902 in real time. If automatic translation is enabled for the electronic device 102, the translation-manager module 106 from FIGS. 1-3 can generate an overlay 906 (e.g., system UI overlay 120) for display on top of, or in front of, the displayed video. The overlay 906 can be resized and/or moved anywhere on the display device 108. In some aspects, the overlay 906 is displayed directly in front of in-app captions (not shown) generated by the media player application, such that the overlay 906 appears to re-render the captions in the target human language 118.

In the example illustrated in FIG. 9, the video playback application is playing a video of two people playing a digital game on an electronic device. One voice in the audio 904 speaks in English, saying, “This time I'm going to win. You'll see!” The ASR-transcription module 308 transcribes this English phrase into English text (e.g., visual content 306 from FIG. 1). The translation-manager module 106 translates the English text into the target human language 118 defined in the system settings (e.g., system settings 212 from FIG. 3), which in this example is Spanish. Then, translated text 908 is rendered in the overlay 906 in the target human language 118 to enable the user of the electronic device 102 to read the Spanish phrase “Esta vez voy a ganar. [symbol] Verás!” In some aspects, the overlay 906 can include both the translated text 908 and the original captions to allow the user to view both simultaneously. Accordingly, any video can be played back by the electronic device 102, and the translation-manager module 106 can provide on-device real-time translations via the overlay 906 (e.g., the system UI overlay 120), without requiring special integration between the system UI overlay 120 and the video playback application.

### Example Methods

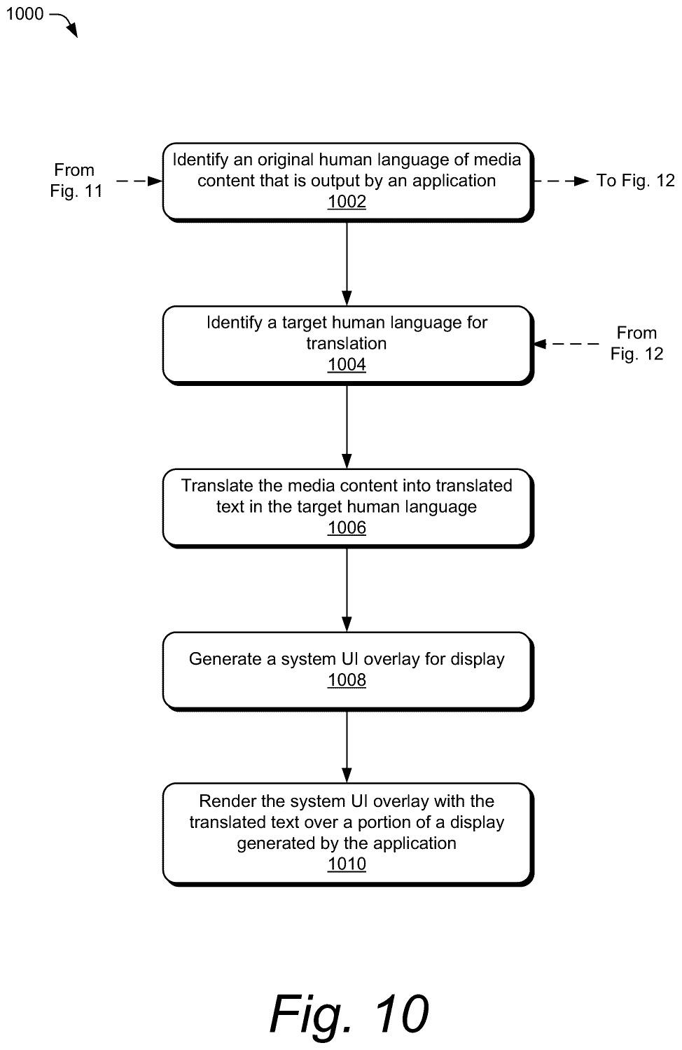

FIGS. 10, 11, and 12 depict example methods 1000, 1100, and 1200, respectively, for on-device real-time translation of media content on a mobile electronic device. The methods 1000, 1100, and 1200 can be performed by the electronic device 102, which uses the translation-manager module 106 to translate the media content and generate an OS-level system UI overlay to re-render displayed text as translated text in a target human language. The methods 1100 and 1200 are supplemental to, and are optionally performed in conjunction with, the method 1000.

The methods 1000, 1100, and 1200 are shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to the example implementation 100 of FIG. 1 or to entities or processes as detailed in FIGS. 2-9, reference to which is made for example only. The techniques are not limited to performance by one entity or multiple entities operating on one device.

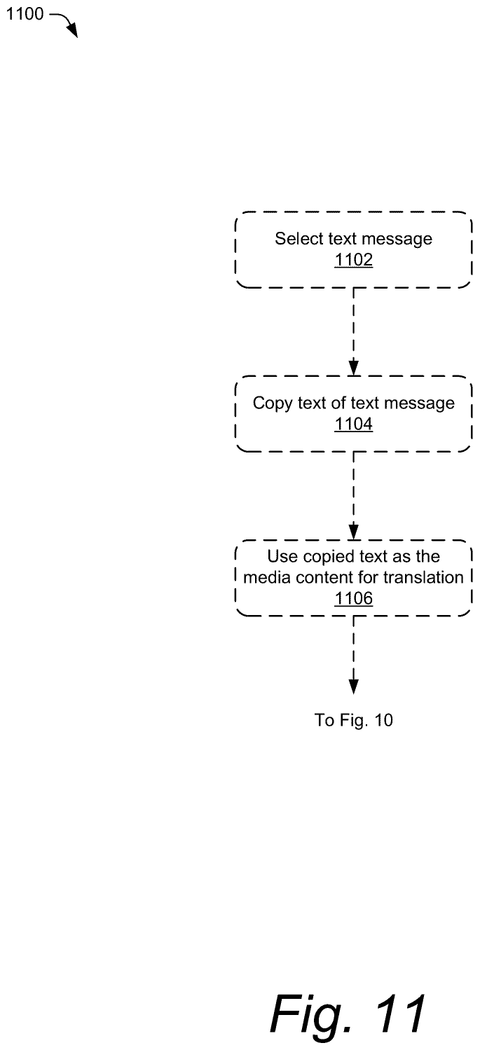

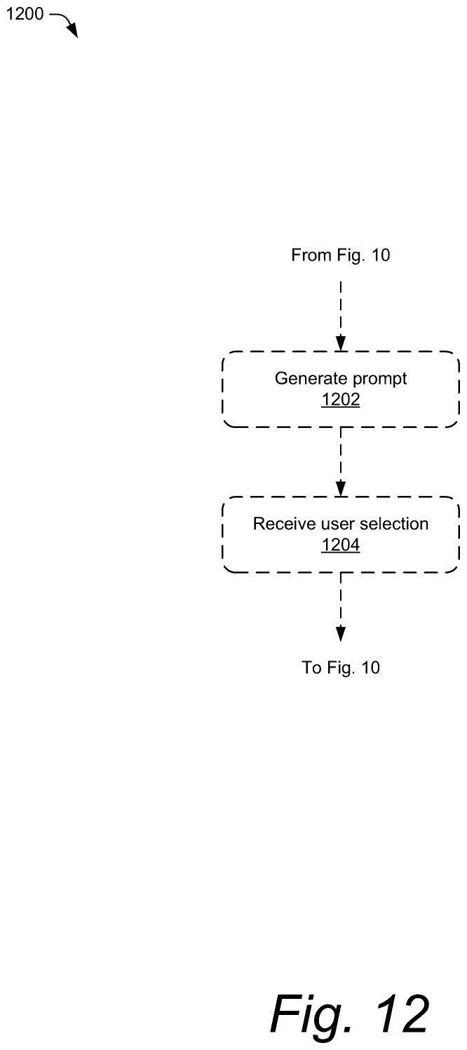

At 1002, an original human language of media content that is output by an application running on the electronic device is identified at an OS level of the mobile electronic device, where the original human language is different than a target human language defined by a user of the mobile electronic device. In aspects, the translation-manager module 106 of the electronic device 102 can identify the original human language 114 of visual text generated by the application 210 running on the electronic device 102. Optionally, the media content may be captured based on a user input, as described with respect to FIG. 11 in more detail below. Optionally, the method may proceed to FIG. 12 to request additional user input for determining a target human language for translation, which is described in more detail below.

At 1004, a target human language is identified for translation. For example, the translation-manager module 106 identifies the target human language 118 based on a user selection of a user-preferred human language. In some aspects, the user selection is received based on a prompt. In another example, the user selection was previously received as part of a user input selecting device settings.

At 1006, the media content is translated into translated text in the target human language. In an example, the translation-manager module 106 utilizes the translation models 318, stored in the memory (e.g., storage media 208) of the electronic device 102 to translate the media content into the translated text.

At 1008, a system UI overlay is generated for display via a display device of the mobile electronic device. For example, the translation-manager module 106 may generate the system UI overlay 120 for use in rendering the translated text.

At 1010, the system UI overlay is rendered over a portion of displayed content corresponding to the application, where the system UI overlay includes the translated text. In an example, the translation-manager module 106 renders the system UI overlay 120 over, or in front of, the display generated by the application 210, and the translated text is rendered within the system UI overlay 120. In some aspects, the electronic device 102 appears to visually replace visual content (e.g., incoming and outgoing text messages, captions to video) in the original human language with translated text in the target human language.

As mentioned, the media content may optionally be captured based on an optional method 1100 described with respect to FIG. 11 for a copy-and-translate command. At 1102, the electronic device 102 optionally selects text displayed on the display device 108. This selection may be responsive to a first user input, which may be a selection gesture (e.g., tap, double-tap, press and hold). In an example, the user may select a text message from a plurality of incoming text messages in a chat conversation conducted through an instant-messaging application.

At 1104, the electronic device copies text of the selected text message. This copying of the text of the selected text message may be responsive to a second user input, which may be a copy command (e.g., selection of a “copy” option or button). The electronic device 102 copies the visual content of the selected text message at the OS level.

At 1106, the electronic device uses the copied text as the media content for translation. This may be responsive to a third user input, which may be a translate command (e.g., selection of a “translate” option or button) to confirm that translation is intended for the copied text. Although 1104 and 1106 are described as actions performed based on user separate user inputs (e.g., the second user input and the third user input), 1104 and 1106 may be performed automatically and sequentially in response to the first user input, which may include a single command to copy and translate. After 1106, the optional method 1100 proceeds to 1004 of FIG. 10.

As mentioned above, the method 1000 may optionally proceed from 1002 to FIG. 12, which depicts a method 1200 for requesting user input for determining a target human language for translation. At 1202, a prompt is generated to request the user selection of the user-preferred human language. In aspects, the prompt is generated via a system UI overlay. The prompt may request the user to confirm whether the user desires the media content displayed on the display device 108 to be translated to the target human language 118.

At 1204, the user selection is received based on a user input associated with the prompt. For example, a user input is received that confirms the user's desire to translate the media content. In aspects, the user input may initiate the translation of the media content by causing the method 1200 to proceed to 1004 of FIG. 10.

Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, including, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

Some examples are described below:

A method for on-device real-time translation of media content on a mobile electronic device, the method including identifying, at an operating-system level of the mobile electronic device, an original human language of media content that is output by an application running on the electronic device, the original human language being different than a target human language defined by a user of the mobile electronic device; translating, at the operating-system level, the media content from the original human language of the media content into translated text in the target human language, the media content translated based on translation models stored in a memory of the mobile electronic device; generating, at the operating-system level, a system UI overlay for display via a display device of the mobile electronic device; and rendering, at the operating-system level, the system UI overlay over a portion of displayed content corresponding to the application, the system UI overlay including the translated text.

The method may further comprise one or more of resizing and moving the system UI overlay on the display device based on user input.

The method may further comprise identifying the target human language for translation based on a user selection of a user-preferred human language.

The user selection may define one or more device settings of the mobile electronic device.

The method may further comprise: after identifying the original human language of the media content and prior to identifying the target human language, generating a prompt to request the user selection of the user-preferred human language; and receiving the user selection based on an additional user input associated with the prompt.

The media content may include text messages of a chat conversation conducted through an instant-messaging application, and the translating of the media content may include automatically translating the text messages of the chat conversation into the target human language.

The method may further comprise, prior to identifying the original human language: selecting, responsive to a first user input, a text message from a plurality of incoming text messages in a chat conversation conducted through an instant-messaging application; copying, responsive to a second user input, the selected text message; and using, responsive to a third user input, the selected text message as the media content for translation.

Based on the device settings being set for word-by-word translation, the method may further comprise, prior to identifying the original human language: selecting, based on a first user input, a word from a plurality of words displayed on the display device as part of the media content output by the application; copying the selected word; and using the selected word as the media content for translation.

The translating of the media content may include automatically translating one or more outgoing text messages of a chat conversation, conducted through an instant-messaging application, into a preferred human language of a recipient of the one or more outgoing text messages.

The media content may include text entered by the user via a keyboard of the mobile electronic device or via transcription by the mobile electronic device from audio spoken by the user; the target human language may correspond to a preferred human language of an intended recipient of the text entered by the user; and the translated text may be included in the system UI overlay may be selectable to send as an outgoing text message to the intended recipient via the application.

The rendering may include using rendering models stored in the memory to cause the translated text to substantially match one or more visual characteristics of native content of the application.

The media content may include audio content; the method may further comprise transcribing, using an automatic speech recognition transcription module, the audio content into visual text in the original human language; and the translating of the media content may include translating the visual text into the target human language for display in the system UI overlay.

The audio content may be part of video content being played back or live-streamed via the application; and the system UI overlay may be rendered to include the translated text as captions to the video content as the video content is played back or live-streamed.

The translation models may include semantic natural-language understanding.

A mobile electronic device comprising: a display device; one or more processors; and memory storing: translation models usable for translation of text from an original human language to a target human language; and instructions that, when executed by the one or more processors, cause the one or more processors to implement a translation-manager module to provide on-device real-time translation of media content that is output by the electronic device by performing the method disclosed above.

### CONCLUSION

Although aspects of the on-device real-time translation of media content on a mobile electronic device have been described in language specific to features and/or methods, the subject of the appended claims is not necessarily limited to the specific features or methods described. Rather, the specific features and methods are disclosed as example implementations of the claimed on-device real-time translation of media content on a mobile electronic device or a corresponding electronic device, and other equivalent features and methods are intended to be within the scope of the appended claims. Further, various different aspects are described, and it is to be appreciated that each described aspect can be implemented independently or in connection with one or more other described aspects.

1. A method comprising:
identifying, at an operating-system level of a mobile electronic device, an original human language of media content that is output by an application running on the mobile electronic device, the original human language being different than a target human language defined by a user of the mobile electronic device;
translating, at the operating-system level, the media content from the original human language of the media content into translated text in the target human language, the media content translated based on translation models stored in a memory of the mobile electronic device;
generating, at the operating-system level, a system UI overlay for display via a display device of the mobile electronic device; and
rendering, at the operating-system level, the system UI overlay at the display device of the mobile electronic device over a portion of displayed content corresponding to the application, the system UI overlay including the translated text.

2. The method of claim 1, further comprising one or more of resizing and moving the system UI overlay on the display device based on a user input.

3. The method of claim 1, further comprising identifying the target human language for translation based on a user selection of a user-preferred human language.

4. The method of claim 3, wherein the user selection sets the user-preferred human language as the target human language in device settings of the mobile electronic device.

5. The method of claim 3, further comprising:
after identifying the original human language of the media content and prior to identifying the target human language, generating a prompt to request the user selection of the target human language; and
receiving the user selection based on an additional user input associated with the prompt.

6. The method of claim 1, claims, wherein:
the media content includes text messages of a chat conversation conducted through an instant-messaging application; and
the translating of the media content includes automatically translating the text messages of the chat conversation into the target human language.

7. The method of claim 1, further comprising, prior to identifying the original human language:
selecting, responsive to a first user input, a text message from a plurality of incoming text messages in a chat conversation conducted through an instant-messaging application;
copying, responsive to a second user input, the selected text message; and
using, responsive to a third user input, the selected text message as the media content for translation.

8. The method of claim 1, based on device settings being set for word-by-word translation, the method further comprises, prior to identifying the original human language:
selecting, based on a first user input, a word from a plurality of words displayed on the display device as part of the media content output by the application;
copying the selected word; and
using the selected word as the media content for translation.

9. The method of claim 1, wherein the translating of the media content includes automatically translating one or more outgoing text messages of a chat conversation, conducted through an instant-messaging application, into a preferred human language of a recipient of the one or more outgoing text messages.

10. The method of claim 1, wherein:
the media content includes text entered by the user via a keyboard of the mobile electronic device or via transcription by the mobile electronic device from voice command provided by the user;
the target human language corresponds to a preferred human language of an intended recipient of the text entered by the user; and
the translated text included in the system UI overlay is selectable to send as an outgoing text message to the intended recipient via the application.

11. The method of claim 1, wherein the rendering includes using rendering models stored in the memory to cause the translated text to substantially match one or more visual characteristics of native content of the application.

12. The method of claim 1, wherein:
the media content includes audio content;
the method further comprises transcribing, using an automatic speech recognition transcription module, the audio content into visual text in the original human language; and
the translating of the media content includes translating the visual text into the target human language for display in the system UI overlay.

13. The method of claim 12, wherein:
the audio content is part of video content being played back or live-streamed via the application; and
the system UI overlay is rendered to include the translated text as captions to the video content as the video content is played back or live-streamed.

14. The method of claim 1, wherein the translation models include semantic natural-language understanding.

15. A mobile electronic device comprising:
a display device;
one or more processors; and
memory storing:
translation models usable for translation of text from a first human language to a second human language; and
instructions that, when executed by the one or more processors, cause the one or more processors to implement a translation-manager module operable to:
identify, at an operating-system level of the mobile electronic device, an original human language of media content that is output by an application running on the mobile electronic device, the original human language of the media content being different than a target human language defined by a user of the mobile electronic device;
translate, at the operating-system level and based on the translation models stored in the memory, the media content from the original human language into translated text in the target human language;
generate, at the operating-system level, a system UI overlay for display via the display device of the mobile electronic device; and
render, at the operating-system level, the system UI overlay at the display device of the mobile electronic device over a portion of displayed content corresponding to the application, the system UI overlay including the translated text.

16. (canceled)

17. The mobile electronic device of claim 15, wherein:
the translation-manager module is further operable to identify the target human language for translation based on a user selection of a user-preferred human language; and
the user selection sets the user-preferred human language as the target human language in device settings of the mobile electronic device.

18. The mobile electronic device of claim 15, wherein the translation-manager module is further operable to, prior to the original human language of the media content being identified:
select, responsive to a first user input, a text message from a plurality of incoming text messages in a chat conversation conducted through an instant-messaging application;
copy, responsive to a second user input, the selected text message; and
use, responsive to a third user input, the selected text message as the media content for translation.

19. The mobile electronic device of claim 15, wherein the translation-manager module is further operable to, based on device settings being set for word-by-word translation and prior to identification of the original human language of the media content:
select, based on a first user input, a word from a plurality of words displayed on the display device as part of the media content that is output by the application;
copy the selected word; and
use the selected word as the media content for translation.

20. The mobile electronic device of claim 15, wherein translation of the media content includes automatic translation of one or more outgoing text messages of a chat conversation, conducted through an instant-messaging application, into a preferred human language of a recipient of the one or more outgoing text messages.

21. A computer-readable medium comprising instructions which, when executed by one or more processors, cause the one or more processors to perform operations including:
identifying, at an operating-system level of a mobile electronic device, an original human language of media content that is output by an application running on the mobile electronic device, the original human language being different than a target human language defined by a user of the mobile electronic device;
translating, at the operating-system level, the media content from the original human language of the media content into translated text in the target human language, the media content translated based on translation models stored in a memory of the mobile electronic device;
generating, at the operating-system level, a system UI overlay for display via a display device of the mobile electronic device; and
rendering, at the operating-system level, the system UI overlay at the display device of the mobile electronic device over a portion of displayed content corresponding to the application, the system UI overlay including the translated text.
